(19) United States
(12) Patent Application Publication
(10) Pub. No.: US 2022/0248130 A1
(43) Pub. Date: Aug. 4, 2022

(54) COAXIALLY OPPOSED SPEAKER PAIR

(71) Applicant: Epsilon Electronics, Inc., Montebello, CA (US)

(72) Inventors: Ronnie Brashear, Avon, IN (US); Kenneth V. Koga, Nipomo, CA (US); Brandon Meyer, Rosemead, CA (US)

(21) Appl. No.: 17/591,573

(22) Filed: Feb. 2, 2022

Related U.S. Application Data
(60) Provisional application No. 63/145,436, filed on Feb. 3, 2021.

(51) Int. Cl. H04R 1/40; H04R 5/02; H04R 1/32; H04R 9/06; H04R 9/04

(52) U.S. Cl. CPC H04R 1/403; H04R 5/02; H04R 9/046; H04R 9/06; H04R 1/323

(57) ABSTRACT

Various embodiments of the present application are directed to a loudspeaker assembly including both a woofer and a tweeter co-axially aligned where the woofer is inverted relative to the tweeter. In such a configuration, the woofer and tweeter fire in opposing directions along the common axis. Aspects of the present disclosure are also directed to thermal management and magnetic decoupling to facilitate compact assembly of the speaker pair.

### CROSS-REFERENCE TO RELATED APPLICATIONS

This application claims the benefit of U.S. provisional application No. 63/145,436, filed 3 Feb. 2021, which is hereby incorporated by reference as though fully set forth herein.

### BACKGROUND

### a. Field

The instant disclosure relates to a co-axially aligned loudspeaker pair.

### b. Background Art

Co-axial loudspeaker pairs (also referred to as speaker pairs) arrange two or more drivers/transducers so that the sound produced from each speaker radiates from essentially the same point in space. Speaker pairs may include a higher frequency band transducer (also referred to as a tweeter) mounted along a common axis with a lower frequency band transducer (also referred to as a woofer).

The foregoing discussion is intended only to illustrate the present field and should not be taken as a disavowal of claim scope.

### BRIEF SUMMARY

Various embodiments of the present application are directed to a loudspeaker assembly including both a woofer and a tweeter co-axially aligned where the tweeter is front-facing and the woofer is rear-facing. In such a configuration, the woofer and tweeter fire in opposing directions along the common axis. As discussed in more detail below, an opposed configuration of the woofer and tweeter transducers allows for a reduced overall depth of the speaker pair. However, such an opposed configuration of the transducers results in the transducers being in close proximity to one another and thereby susceptible to magnetic interference and over-heating. Various embodiments of the present disclosure are directed to thermal management and magnetic decoupling to facilitate the compact assembly of a co-axially opposed speaker pair.

In a first example embodiment, a speaker pair is disclosed including a first speaker and a second speaker co-axially aligned with and opposed to the first speaker. In more specific embodiments, the first speaker is a forward-facing tweeter, and the second speaker is a rear-facing woofer.

In another example embodiment, a speaker pair is disclosed including a first speaker and a second speaker. The second speaker having a woofer electro-mechanical structure, support structure, backplate and a basket. The basket is coupled to the woofer electro-mechanical structure via the backplate and the support structure. The support structure extends distally along a longitudinal axis of the speaker pair away from the backplate. The woofer electro-mechanical structure is directly coupled to and faces the support structure, and the first speaker faces away and is coupled to a distal end of the woofer electro-mechanical structure.

The foregoing and other aspects, features, details, utilities, and advantages of the present disclosure will be apparent from reading the following description and claims, and from reviewing the accompanying drawings.

### BRIEF DESCRIPTION OF THE DRAWINGS

Various example embodiments may be more completely understood in consideration of the following detailed description in connection with the accompanying drawings, in which:

FIG. 1 is an isometric top view of a co-axially opposed speaker pair, consistent with various embodiments of the present disclosure;

FIG. 2 is a cross-sectional side view of the co-axially opposed speaker pair of FIG. 1, consistent with various embodiments of the present disclosure;

FIG. 3 is a detailed cross-sectional side view of the co-axially opposed speaker pair of FIG. 1, consistent with various embodiments of the present disclosure; and

FIG. 4 is a further detailed cross-sectional side view of the co-axially opposed speaker pair of FIG. 1, consistent with various embodiments of the present disclosure.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION OF EMBODIMENTS

Various embodiments of the present disclosure are directed to a loudspeaker assembly including both a woofer and a tweeter co-axially aligned with the tweeter front-facing and the woofer rear-facing. In other words, an audio reproduction transducer (speaker) with an inverted electro-mechanical structure and a coaxially mounted tweeter. As discussed in more detail below, an opposed configuration of the woofer and tweeter transducers allows for a reduced overall depth of the speaker pair. However, such an opposed configuration of the transducers results in the transducers being in close proximity to one another and thereby susceptible to magnetic interference and over-heating. Various embodiments of the present disclosure are directed to thermal management and magnetic decoupling to facilitate the compact assembly of the co-axially opposed speaker pair.

More specific embodiments of the present disclosure are directed to an electro-mechanical structure of an inverted audio reproduction transducer with tweeter, further including a thermal management system to extract heat away from critical, thermally sensitive components and/or shielding to magnetically decouple the transducer and the tweeter.

Details of the various embodiments of the present disclosure are described below with specific reference to the figures.

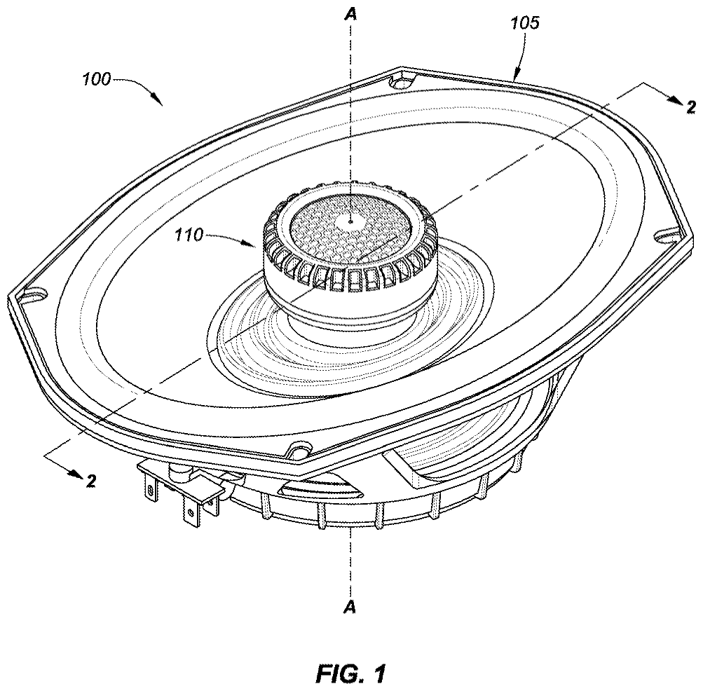

FIG. 1 is an isometric top view of a co-axially opposed speaker pair 100, consistent with various embodiments of the present disclosure. The speaker pair 100 includes a woofer assembly 105 and a tweeter assembly 110. Both the woofer and tweeter assemblies are co-axially aligned along Axis A. As discussed in more detail below, the tweeter is forward facing and the woofer is rear-facing. As a result, the speaker pair 100 is more compact than a co-axially aligned speaker pair with both the tweeter and woofer forward facing while addressing possible thermal and magnetic interference concerns associated with such a layout.

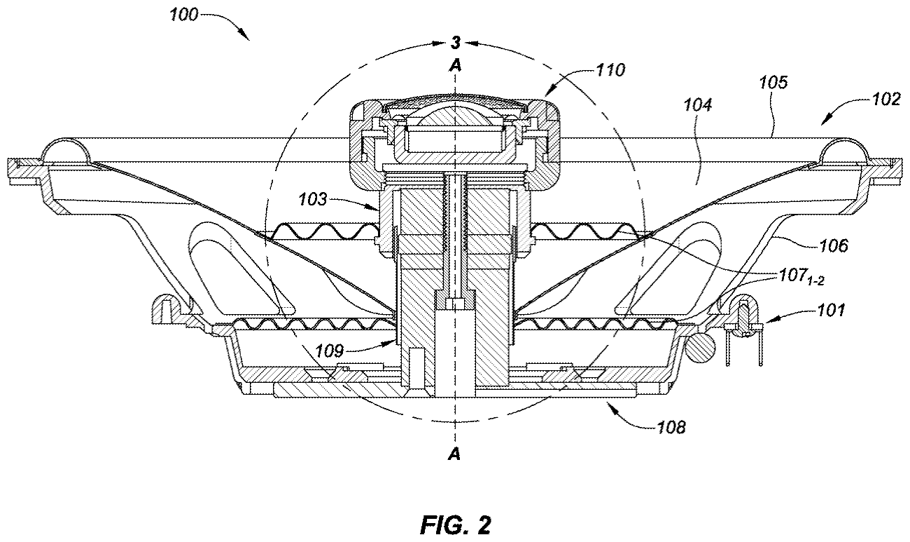

FIG. 2 is a cross-sectional side view of the co-axially opposed speaker pair 100 of FIG. 1, consistent with various embodiments of the present disclosure. The woofer assembly 102 includes traditional speaker components including a woofer electro-mechanical structure 103, diaphragm 104, suspension 105, basket 106, backplate 108, and terminals 101. To facilitate the rear-facing orientation of the woofer electro-mechanical structure 103, two spiders 107₁₋₂ may be utilized. The first spider 107₁ extends between a support structure 109 and the diaphragm 104, and the second spider 107₂ extends between the support structure 109 and an interface of the backplate 108 and the basket 106. In such an embodiment, at least a portion of the diaphragm 104 is positioned between the two spiders 107₁₋₂. The smaller spider 107₁, in the present embodiment, also functions as a moisture/corrosive elements barrier where such moisture/corrosive elements may be present in the ambient air in which the speaker pair 100 is operating. The spider 107₁ prevents the moisture/corrosive elements from entering the electromechanical structure 103 of the speaker pair 100. Should moisture contact the electromechanical structure, a direct short could result damaging one or more of the electronic components of the speaker pair 100 or even components of the audio signal source. Corrosive elements in the air (such as salt) may reduce the usable lifespan of sensitive materials in the electro-mechanical structure (e.g., adhesives, electronic isolating coatings, raw aluminum, steel, etc.).

The support structure 109 extends along an Axis A and is coupled to a top-surface of the backplate 108. A (rear-facing) woofer electro-mechanical structure 103 is positioned at a distal end of the support structure 109, with a tweeter assembly 110 coupled to the woofer electro-mechanical structure 103 opposite of the support structure 109. Accordingly, the woofer electro-mechanical structure 103 and the tweeter assembly 111 are placed back-to-back (i.e., an opposing configuration). Prior to the present disclosure, such back-to-back positioning of the tweeter and woofer electro-mechanical structures would not have been feasible as the resulting speaker pair would be prone to overheating and electromagnetic interference between voice coils that would have degraded the resulting sound quality. Various aspects of the present disclosure solve the thermal and electromagnetic interference problems related to back-to-back placement of the tweeter and woofer electro-mechanical structures—thereby facilitating an improved co-axial speaker pair with a reduced height and desirable sound characteristics. In one specific experimental embodiment of the present disclosure, during sustained operation of the speaker pair 100 maximum surface temperature was measured at an interface of the tweeter and woofer electro-mechanical structures of less than 101° Fahrenheit. Various embodiments of the present disclosure, by virtue of their superior heat dissipation away from the voice coils and magnets, also benefit from extended usable lifespans for the voice coils and magnetic materials. Further, the present invention prevents the degradation of flux level in the rare-earth magnets (such as neodymium) associated with prolonged heat exposure.

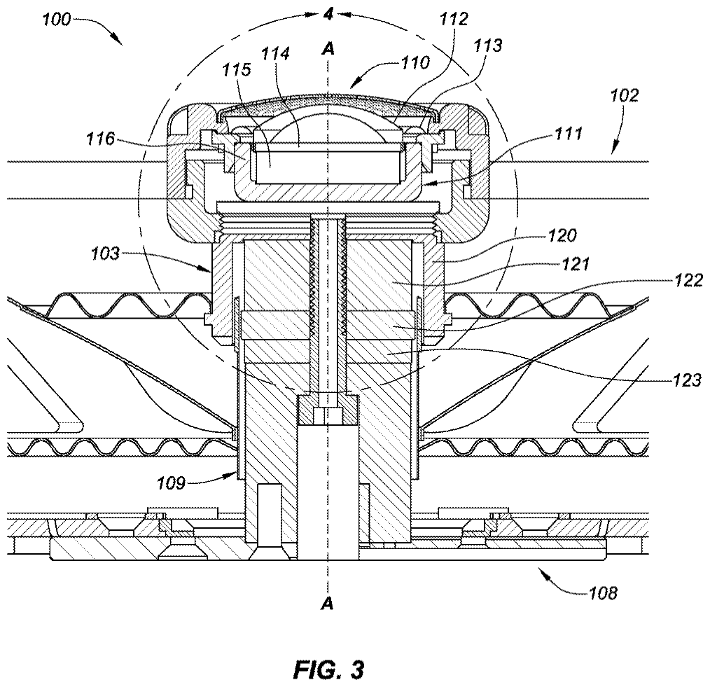

FIG. 3 is a detailed cross-sectional side view of the co-axially opposed speaker pair 100 of FIG. 1, consistent with various embodiments of the present disclosure. FIG. 3 further details the support structure 109 extending between backplate 108 and tweeter assembly 110/woofer electro-mechanical structure 103. As discussed above, the woofer electro-mechanical structure 103 is mounted to a distal end of the support structure 109, and the tweeter assembly 110 is mounted to a distal end of the woofer electro-mechanical structure 103.

The rear-facing woofer electro-mechanical structure 103 includes a steel top plate 122 sandwiched between rare earth magnets 121 and 123. Though not shown in FIG. 3, the rare Earth magnet encompasses a voice coil (and core). Finally, a yoke 120 encompasses the steel top plate 122, the magnet 121, the voice coil (and core), and at least a portion of the magnet 123. The yoke may be a U or pot yoke.

The rare earth magnet 121 generates a first opposing magnetic field. The yoke 120 transfers a first opposing magnetic field circuit of the first opposing magnetic field to the voice coil, and the steel top plate 122 transfers a second opposing magnetic field circuit of the first opposing magnetic field to the voice coil. The additional rare earth magnet 123 further increases the flux density of the first opposing magnetic field.

As shown in FIG. 3, a tweeter assembly 110 is mounted on a distal end of the woofer electro-mechanical structure 103. The tweeter housing 117 of the tweeter assembly 110 may be coupled to the electro-mechanical structure 103 using a combination of male/female threads, for example. Various other methodologies to couple the mechanical structure 103 to the tweeter housing 117 would be readily understood and implemented by one of ordinary skill in the art.

Tweeter assembly 110 includes a (front-facing) tweeter electromechanical structure 111 with at least a suspension 113, diaphragm 112, steel top plate 114, rare-Earth magnet 115, and yoke 116. The yoke 116 may be a U or pot yoke. The yoke 116 encompasses the steel top plate 114, rare-Earth magnet 115, voice coil (not shown) and optionally a core.

The rare-Earth magnet 115 of the tweeter assembly 110 generates a second opposing magnetic field. The steel top plate 114 transfers a first portion of the second opposing magnetic field circuit to the voice coil, and the yoke 116 transfers a second portion of the second opposing magnetic field circuit to the voice coil. As a result, the respective tweeter and woofer electromechanical structures are magnetically decoupled from one another and therefore do not interfere with one another during operation while being positioned in close physical proximity.

In one embodiment of the present disclosure, and as illustrated in the embodiment of FIG. 3, a support structure 109 and backplate 108 are bolted together and both components consist (essentially) of an aluminum alloy. In yet another embodiment, the support structure 109 and the backplate 108 may be one contiguous structure (e.g., forged, welded, etc.) and consist of a steel alloy.

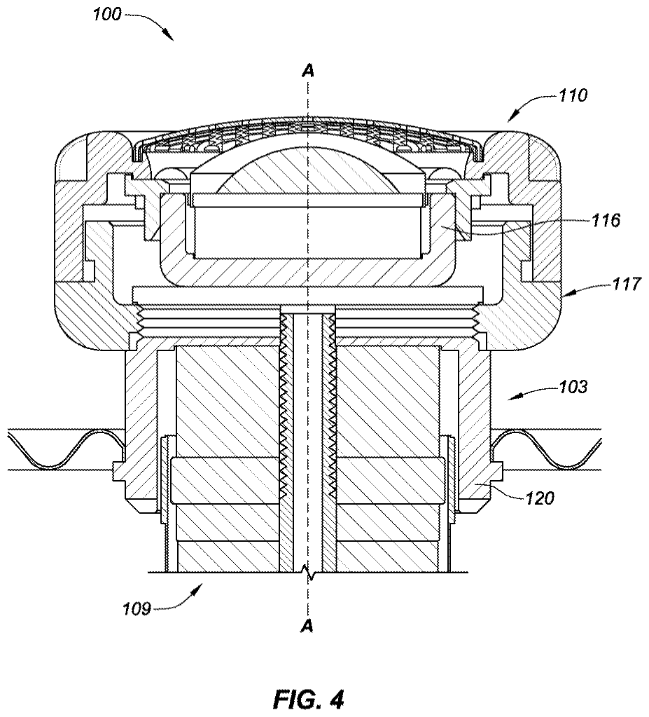

FIG. 4 is a further detailed cross-sectional side view of the co-axially opposed speaker pair 110 of FIG. 1, consistent with various embodiments of the present disclosure. As discussed in more detail above, woofer electro-mechanical structure 103 and tweeter assembly 110 are coupled to a distal end of the support structure 109.

As discussed above, the woofer electro-mechanical structure 103 and the tweeter assembly 110, especially in view of their close proximity in the co-axially opposed speaker pair arrangement disclosed herein, are susceptible to overheating due to their close proximity to one another. To mitigate excess heat in the co-axially opposed speaker pair 100 which may negatively impact resulting sound quality, the support structure 109, tweeter housing 117, woofer yoke 120 and backplate 108 (shown in FIG. 3) draw heat away from the woofer and tweeter electro-mechanical structures. In one example embodiment, one or more of the support structure 109, tweeter housing 117, woofer yoke 120 and backplate 108 may consist of an aluminum alloy. In some specific embodiments, a die-cast aluminum alloy such as A380 may be utilized for one or more of the support structure 109, the tweeter housing 117, the woofer yoke 120 and the backplate 108. In yet other embodiments, these components of the speaker pair 100 may consist of any material with high thermal transmissivity (noting that the woofer yoke 120 also has requirements with respect to its magnetic field conductivity). These high thermal transmissivity components draw heat away from the woofer electro-mechanical structure 103 and the tweeter assembly 110 and into convective contact with air.

In some specific embodiments of the present disclosure, one or more of the support structure 109, tweeter housing 117, woofer yoke 120 and backplate 108 (not shown in FIG. 4) may include cooling fins which further improve heat dissipation away from the woofer electro-mechanical structure 103 and the tweeter assembly 110.

In response to operation of the tweeter assembly 110, yoke 116 experiences heat build-up. The tweeter housing 117 is in conductive contact with the yoke 116 and its material characteristics in conjunction with a large surface area exposed to air facilitates heat transfer away from the tweeter assembly 110 (including the yoke 116) into the air.

Yoke 120 of the woofer electro-mechanical structure 103, in addition to completing the opposing magnetic fields circuit thru the woofer voice coil, also thermally couples the voice coil and other components of the structure 103 through an external surface of the yoke 120 to the air. As a result, heat is transferred away from the woofer electro-mechanical structure 103 through the yoke 120 in the air. In addition to the yoke 120, support structure 109 also draws heat away from the woofer electro-mechanical structure 103. In some specific embodiments, as the tweeter assembly 110 is also in thermally conductive contact with the support structure 109 via yoke 120 of the woofer, the support structure 109 may draw heat away from both the tweeter assembly 110 and woofer electro-mechanical structure 103.

While various embodiments of the present disclosure have been directed to an opposed speaker pair, the teachings of the present disclosure may also be readily applied to implement a co-axial three-way speaker.

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A speaker pair comprising:
a first speaker; and
a second speaker coaxially aligned with and opposed to the first speaker.

2. The speaker pair of claim 1, wherein the first speaker is a forward-facing tweeter, and the second speaker is a rear-facing woofer.

3. The speaker pair of claim 1, wherein the first speaker includes a first electro-mechanical structure facing outward, the second speaker includes a second electro-mechanical structure facing inward, and the first speaker and the second electro-mechanical structure are directly coupled to one another.

4. The speaker pair of claim 3, further including a support structure that mechanically couples the first speaker and the second electro-mechanical structure to the rest of the second speaker.

5. The speaker pair of claim 1, wherein the first speaker includes a tweeter housing, and the second speaker includes a yoke; and
wherein the tweeter housing and the yoke are directly coupled to one another.

6. The speaker pair of claim 5, wherein the first speaker includes a first electro-mechanical structure facing outward, the second speaker includes a second electro-mechanical structure facing inward, and the first speaker and the second electro-mechanical structure are directly coupled to one another; and
wherein the first and second electro-mechanical structures are configured and arranged to be magnetically isolated from one another during operation of the speaker pair.

7. The speaker pair of claim 1, wherein the first speaker includes a first rare-Earth magnet between a first steel top plate and a first yoke, and the second speaker includes a second steel top plate between second and third rare-Earth magnets, and a second yoke that extends circumferentially about the second steel top plate and at least one of the second and third rare-Earth magnets.

8. The speaker pair of claim 7, wherein the first yoke circumferentially extends about the first rare-Earth magnet and the first steel top plate.

9. The speaker pair of claim 7, wherein the first speaker further includes a housing that houses the first rare-Earth magnet, the first steel top plate and the first yoke; and the housing is directly coupled to the second yoke of the second speaker.

10. A speaker pair comprising:
a first speaker; and
a second speaker including a woofer electro-mechanical structure, support structure, backplate and a basket, wherein the basket is coupled to the woofer electro-mechanical structure via the backplate and the support structure, the support structure extending distally along a longitudinal axis of the speaker pair away from the backplate, the woofer electro-mechanical structure facing the support structure and directly coupled thereto; and
wherein the first speaker is coupled to a distal end of the woofer electro-mechanical structure and faces away from the woofer electro-mechanical structure.

11. The speaker pair of claim 10, wherein the first speaker includes a tweeter housing and a tweeter electro-mechanical structure housed within the tweeter housing;
wherein the woofer electro-mechanical structure includes a steel top plate between first and second rare-Earth magnets, and a yoke that extends circumferentially about the steel top plate and at least one of the two rare-Earth magnets; and
wherein the tweeter housing, the yoke, and the support structure are configured and arranged to draw heat away from the first speaker and the woofer electro-mechanical structure.

12. The speaker pair of claim 11, wherein the tweeter housing, the yoke, and the support structure consist of an aluminum alloy.

13. The speaker pair of claim 10, wherein the woofer electro-mechanical structure includes a first voice coil, a first steel top plate between first and second rare-Earth magnets, and a first yoke that extends circumferentially about the first steel top plate, first voice coil and at least one of the two rare-Earth magnets; and
wherein the first rare-Earth magnet is configured and arranged to generate a first opposing magnetic field;
wherein the first yoke is configured and arranged to transfer a first opposing magnetic field circuit of the first opposing magnetic field to the first voice coil;
wherein the first steel top plate is configured and arranged to transfer a second opposing magnetic field circuit of the first opposing magnetic field to the first voice coil; and
wherein the second rare-Earth magnet is configured and arranged to increase flux density of the first opposing magnetic field.

14. The speaker pair of claim 13, wherein the first speaker includes a tweeter electro-mechanical structure having a second steel top plate, a third rare-Earth magnet, a second voice coil and a second yoke;
wherein the third rare-Earth magnet is configured and arranged to generate a second opposing magnetic field;
wherein the second steel top plate is configured and arranged to transfer a third opposing magnetic field circuit of the second opposing magnetic field to the second voice coil;
wherein the second yoke is configured and arranged to transfer a fourth opposing magnetic field circuit of the second opposing magnetic field to the second voice coil; and
wherein the first voice coil is magnetically shielded from the second opposing magnetic field and the second voice coil is magnetically shielded from the first opposing magnetic field.
